(19) United States
(12) Patent Application Publication
(10) Pub. No.: US 2025/0060599 A1
(43) Pub. Date: Feb. 20, 2025

(54) ADJUSTABLE SECUREMENT ARM

(71) Applicant: Apple Inc., Cupertino, CA (US)

(72) Inventors: Alison B. Shutzberg, San Francisco, CA (US); Paul Williams, Seattle, WA (US)

(21) Appl. No.: 18/435,052

(22) Filed: Feb. 7, 2024

Related U.S. Application Data
(60) Provisional application No. 63/520,277, filed on Aug. 17, 2023.

(51) Int. Cl. G02B 27/01; G02C 5/20; G02C 5/22; G02C 11/00

(52) U.S. Cl. CPC G02B 27/0176; G02C 5/20; G02C 5/2209; G02C 5/2227; G02C 11/10; G02B 2027/0154; G02B 2027/0178; G02C 2200/02; G02C 2200/26

(57) ABSTRACT

A head-mountable electronic device can include a viewing frame and a securement arm extending from the viewing frame. The securement arm can include a proximal portion connected to the viewing frame with a first electronic component disposed within the proximal portion and a distal portion attached to the proximal portion with an extendable connector. The distal portion can include a second electronic component. An electrical cable can extend through the connector and electrically connect the first electronic component and the second electronic component.

### CROSS-REFERENCE TO RELATED APPLICATION(S)

This claims priority to U.S. Provisional Patent Application No. 63/520,277 filed 17 Aug. 2023, and entitled “ADJUSTABLE SECUREMENT ARM,” the entire disclosure of which is hereby incorporated by reference.

### FIELD

The described embodiments relate generally to electronic devices. More particularly, the present embodiments relate to head-mountable electronic devices.

### BACKGROUND

Recent advances in portable computing have enabled head-mountable optical devices that provide augmented and virtual reality experiences to users. Various components of these devices, such as display screens, viewing frames, securement arms, speakers, batteries, and the like, operate together to provide an immersive and comfortable experience. However, the anatomy of each user's head is unique. One user's head can be larger than another's or can be a different shape. Other anatomical features, including relative positions of a user's nose, forehead, and ears, can vary widely as well. The anatomical variety of heads presents a challenge for head-mountable devices designed for comfort and reliability.

In some optical devices, for example, securement arms that extend along, or make contact with, opposing sides of a user's head can be used to secure the device to the user's head. However, the dimensions, angles, shape, and other physical characteristics of the arms that may be sufficient to comfortably and reliably secure the device to one user's head may not be sufficient to comfortably and reliably secure the device to another user's head.

Additionally, optical devices can be used in a variety of different settings and during a variety of different activities. These can range from lying down still in bed to mountain biking or hiking outdoors. Thus, even for a single user, the securement arms of a head-mountable device that are comfortable and sufficient for securing the device during one activity may not be as well suited for another activity.

Furthermore, head-mountable optical devices can include a number of electronic components configured to operate together to produce an altered or virtual reality experience to the user. Users often desire lightweight, compact devices that are comfortable, portable, long lasting, and easily handled. Thus, the physical configuration of these electronic components, including batteries, speakers, processors, and so forth, affects the quality of the user's experience.

Accordingly, what is needed in the art are head-mountable optical devices and systems providing users having a wide variety of anatomical features and who participate in a wide variety of activities with comfortable and reliable components.

### SUMMARY

In at least one example of the present disclosure, a head-mountable electronic device can include a viewing frame and a securement arm extending from the viewing frame. The securement arm can include a proximal portion connected to the viewing frame with a first electronic component disposed within the proximal portion and a distal portion attached to the proximal portion with an extendable connector. The distal portion can include a second electronic component. An electrical cable can extend through the connector and electrically connect the first electronic component and the second electronic component.

In one example, the electrical cable can include a planar flex. In one example, the second electrical component includes a battery. In one example, the first electronic component includes a speaker. In at least one example, the head-mountable electronic device can include an elastic sleeve disposed over the connector. In some examples, the connector can include a screw extender. In this example, first rotation of a screw in a first direction extends the securement arm and a second rotation of the screw in a second direction shortens the securement arm. In such an example, the screw defines a channel and the electrical cable is disposed within the channel.

In at least one example of the present disclosure, a securement arm for a wearable electronic device includes a first portion connected to a viewing frame of the optical device and a second portion attached to the first portion with a connector. In some examples, the connector is configured to adjust the length of the securement arm. The securement arm can further include an electrical wire extending through the connector.

In one example, the connector can include a ball detent mechanism. The ball detent mechanism can include a series of apertures defined by the first or second portion and a ball biased toward an aperture of the series of aperture by a spring. The ball can be disposed in the aperture. The ball can resist lateral movement of the first portion relative to the second portion. In one example, the first portion and the second portion are operably connected in a rack-and-pinion linear gear arrangement. In this example, the second portion slides laterally with respect to the first portion between a retracted and an extended position. In some examples, the connector can include a twist gear configured to engage in a compressed position and an extended position and a spring biasing the twist gear and configured to extend the connector. In this example, a first rotation of the second portion causes the twist gear to disengage from the compressed position and a second rotation of the second portion causes the twist gear to engage in the extended position. In some examples, the connector defines a cavity and includes an interchangeable extender including a proximal end and a distal end opposite the proximal end. In this example, the proximal end is coupled to the first portion and the distal end is coupled to the second portion and the electrical wire is disposed in the cavity. In some examples, the proximal end of the extender couples to the first portion and the distal end of the extender couples to the second portion in an interference fit. In some examples, the proximal end of the extender couples to the first portion and the distal end of the extender couples to the second portion in a magnet connection.

In one example, the connector includes a motor configured to adjust the length of the securement arm. In one example, the securement arm further includes a sleeve disposed over the connector. In this example, the sleeve can include at least one of elastane, nylon, or neoprene.

In at least one example of the present disclosure, a head mountable device includes a viewing frame and a securement arm extending from the viewing frame. The securement arm can include a proximal portion connected to the viewing frame and a distal portion secured to the proximal portion by an extendable coupling. In some examples, the extendable coupling can include a retainer configured to maintain the extendable coupling at a predetermined length. In one example, the retainer can include an adjustable screw set. In this example, the adjustable set screw can be a first set screw and rotation of the first set screw adjusts the length of the securement arm and the retainer further comprises a second set screw. In some examples, rotation of the second set screw adjusts an angle of the distal portion relative to the proximal portion.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a top view of an example of a head-mountable electronic device worn by a user;

FIG. 2A shows a top view of an example of a head-mountable electronic device worn by a user;

FIG. 2B shows a top view of an example of a head-mountable electronic device worn by a user;

FIG. 3A shows a side view of an example of a head-mountable device;

FIG. 3B shows a side view of an example of a head-mountable device;

FIG. 4A shows a side view of an example of a securement arm of a head-mountable device;

FIG. 4B shows a side view of the securement arm of FIG. 4A extended;

FIG. 5A shows a side view of an example of a securement arm;

FIG. 5B shows a side view of the securement arm of FIG. 5A extended;

FIG. 6A shows a side view of an example of a securement arm;

FIG. 6B shows a side view of the securement arm of FIG. 6A with the distal end rotated;

FIG. 6C shows a side view of the securement arm of FIG. 6A extended;

FIG. 7A shows a cross-sectional view of an example of a securement arm of a head-mountable device;

FIG. 7B shows a cross-sectional view of the securement arm of FIG. 7A extended;

FIG. 8A shows a perspective view of an example head-mountable device with interchangeable extenders;

FIG. 8B shows a perspective view of an example head-mountable device with interchangeable extenders;

FIG. 8C shows a perspective view of an interchangeable extender having a magnet connection;

FIG. 8D shows a perspective view of an interchangeable extender having an interference fit connection;

FIG. 9 shows a perspective view of an example of a securement arm of a head-mountable device;

FIG. 10A shows a cross-sectional view of an example of a securement arm of a head-mountable device;

FIG. 10B shows a cross-sectional view of the securement arm of FIG. 10A extended; and

FIG. 10C shows a top view of the securement arm of FIG. 10A.

### DETAILED DESCRIPTION

Detailed reference will now be made to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to electronic devices. More particularly, the present disclosure relates to head-mountable electronic devices. In at least one example, a head-mountable electronic device can include a viewing frame and a securement arm extending from the viewing frame. Examples of head-mountable electronic devices can include virtual reality or augmented reality devices that include an optical component. In the case of augmented reality devices, optical eyeglasses can be worn on the head of a user such that optical lenses and/or optical displays are positioned in front of the user's eyes. In another example, a virtual reality device can be worn on the head of a user such that a display screen is positioned in front of the user's eyes. The viewing frame can include a housing or other structural component supporting or housing the optical component, for example lenses or screens.

Examples of the present disclosure can include a securement arm extending from the viewing frame, which can be fixed in position relative to the viewing frame or secured thereto. An optical electronic device can include two opposing securement arms that can apply pressure to or around a user's head to maintain the viewing frame resting on the user's nose and/or cheeks. In some examples, the securement arms can rest on top of the user's ears to assist in securing the head-mountable optical device to the head of the user.

The securement arm can include multiple portions and one or more electronic components used to operate the head-mountable electronic device. These components can include any components used by the head-mountable electronic device to produce a virtual or augmented reality experience. For example, electronic components of the securement arm can include one or more speakers, processors, batteries, circuitry components including wires and circuit boards, or any other electronic components used in the head-mountable device to deliver augmented or virtual reality visuals, sounds, and other outputs. Disposing various electronic components within the securement arm reduces weight and space needed for the viewing frame and lenses and/or display screens of the device. This redistributed weight can relieve pressure of sensitive features like the user's nose and cheeks to create a more comfortable experience. This weight distribution can also be used to balance weight from the front of the device (at the viewing frame) to the back of the device (at the distal ends of the securement arms), resulting in a more secure and comfortable experience.

In examples where the securement arm includes multiple portions, a first portion or proximal portion can include a first electronic device and a second portion or distal portion can include a second electronic device. The first portion can be attached and/or connected to the second portion with a connector. In at least one example, the first electronic device and the second electronic device can be electrically connected with an electrical wire or cable extending through the connector. The connection can be extendable to adjust the length of the securement arm. The electrical wire can extend through the connector and be disposed such that extending the connector does not affect the electrically connectivity of the first electrical component with the second electrical component.

Head-mountable electronic devices, such as head-mountable optical devices delivering virtual and augmented reality experiences, can be used in a variety of different settings and during a variety of activities. For example, a user may lie down on a sofa or a bed while watching a movie or playing a game with a head-mountable virtual reality device. That same device, or some other augmented reality device, such as electronic glasses, can be used while exercising indoors on an exercise machine. Similarly, devices like augmented reality glasses can be used while being active outdoors, either while hiking, biking, or swimming. The devices of the present disclosure include components, such as securement arms, which can be adapted to effectively secure head-mountable devices to the user during any of the various activities in which the user participates and accommodate a variety of users.

For example, the head measurements and anatomical features of each user vary such that a securement arm of the same length, shape, and curvature, may not be appropriate for every user. For example, some heads are rounder than others. Some heads are larger or smaller and the position of a user's nose relative to their eyes can vary. The position of a user's ears relative to their nose or forehead can vary from one user to another such that a set of securement arms that effectively secure a head-mountable device to one user may not effectively secure the same device to anther user.

In addition, manufacturing individualized arms for each unique customer can be burdensome and often economically unfeasible. The head-mountable electronic devices of the present disclosure include securement arms and components that can be altered and extended to accommodate each user and each activity. The same user can adjust the securement arms of a device, for example, to extend and rest on the cars in a natural manner when using the head-mountable device for exercise or other active scenarios. The same user can readjust the securement arms for a more comfortable fit while using the head-mountable device for less active scenarios, including lying down, sitting, or walking. In addition, some head-mountable devices may be used by multiple people, including multiple people in a household or business office, with each person having a different head geometry. Securement arms for devices described herein can be customized for the same device to be comfortably and effectively used by each of the multiple individuals using the device.

In one example, the second portion can be extended and secured relative to the first portion of the securement arm to adjust the length of the securement arms. In one example, the second portion can be a distal portion and the first portion can be a proximal portion secured to the viewing frame. The distal portion can couple to the proximal portion by the extendable connector. An electrical cable can extend through the connector to electrically connect components disposed in the distal portion to components disposed in the proximal portion. To accommodate the cable through an extending connector, the cable can be directed and/or disposed in a variety of ways. For example, the cable can be coiled when the securement arm is disposed in a contracted arrangement and protracted when the securement arm is in an extended arrangement. In this way, the securement arm can be adjusted and customized to each user or for a single user participating in different activities.

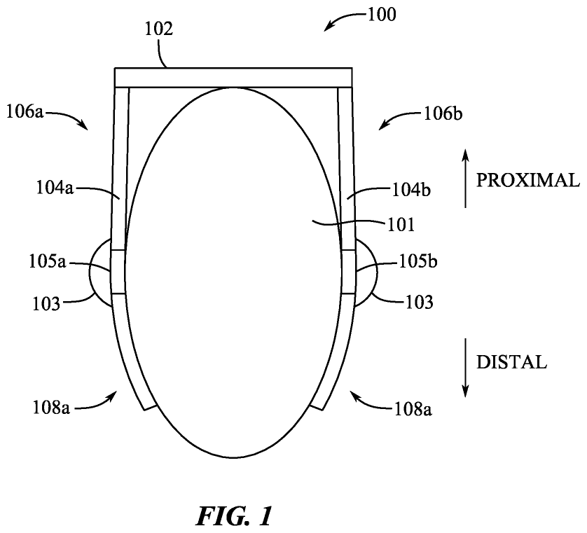

These and other embodiments are discussed below with reference to FIGS. 1-10C. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a top view of an example of a head-mountable electronic device 100 worn on the head 101 of a user. The device 100 can include a viewing frame 102 configured to secure one or more optical lenses or display screens in front of the eyes of the user. The device 100 can also include one or more securement arms 104a, 104b secured to the viewing frame 102 and extending distally toward the rear of the user's head 101. In the illustrated example, the securement arms 104a, 104b extend over the user's cars 103. The securement arms 104a, 104b can include a connector 105a, 105b. The connector 105a, 105b allows the securement arms 104a, 104b to extend and/or lengthen to secure the device 100 to the user's head 101. The securement arms 104a, 104b rest on the user's ears 103 and secure the device 100 via friction between the securement arms 104a, 104b and the head 101 and/or cars 103.

In at least one example, the securement arms 104a, 104b can include a first proximal portion 106a, 106b and a second distal portion 108a, 108b, respectively. The distal portion 108a, 108b of each arm 104a, 104b can be extended away from the first proximal portion 106a, 106b to balance the device 100 or better secure the device 100. Further, in some examples, as shown in the illustrated example of FIG. 1, at least the distal portions 108a, 108b of the arms 104a, 104b can also adjust an angle to make contact with the head 101. In other words, the distal portions 108a, 108b of the arms 104a, 104b can adjust an angle of the distal portion relative to the proximal portion. As such, the arms 104a, 104b can extend distally and also curve around a portion of the back of user's head 101, as shown, and prevent the viewing frame 102 from being pulled forward proximally off the face/head 101 of the user.

However, as noted above, the head 101 of the user can be a unique shape and size with a unique position of each car 103 such that the length of the securement arms 104a, 104b of the device 100 shown in FIG. 1 may not be a match for the anatomy of the head of a different user. In general, the securement arms 104a, 104b length and the length between the arms 104a, 104b and head 101 improve the resistance of the arms 104a, 104b to forces pulling the viewing frame 102 proximally off the user's head 101. Such forces can arise from jostling and bumping during normal use of the device 100 or more detrimentally during falls or contact with other objects during use. Thus, the extension fit of the securement arms 104a, 104b, and more particularly the connectors 105a, 105b, which can be effective for extending the securement arms 104a, 104b and fitting the device 100 on the head 101 shown in FIG. 1, may not be effective for a user with a head of a different size or shape.

Any of the features, components, and/or parts, including the arrangements and configurations thereof shown in FIG. 1 can be included, cither alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1.

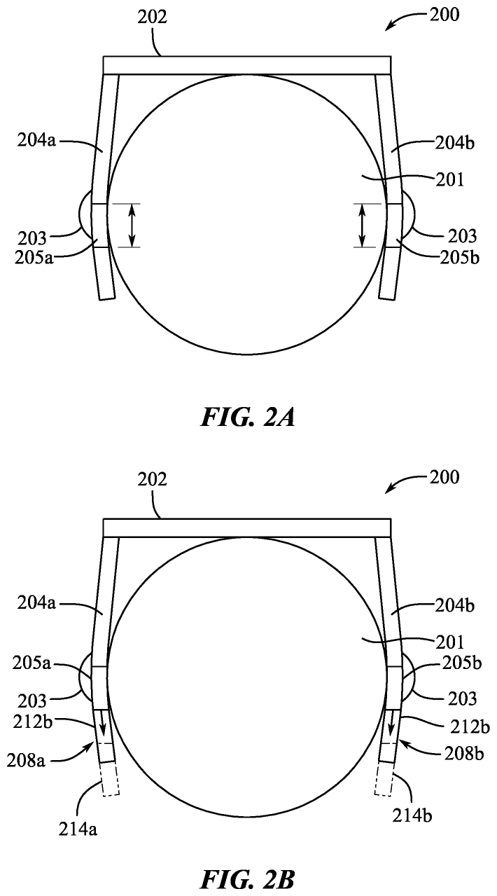

A user having a head 201 of a different size and shape as that of the head 101 shown in FIG. 1 is shown in FIG. 2. The same or similar head-mountable electronic device 200 can include a viewing frame 202 secured, at least in part, to the user's head 201 via one or more securement arms 204a, 204b. As show, the securement arms 204a, 204b can extend distally along opposing sides of the head 201. In the example shown, the arms 204a, 204b can include the connectors 205a, 205b that can extend over the user's ears 203 and toward the rear of the user's head 201. In some examples, the extension of the arms can include better retention of the device 200 on the head 201 and better stability of the viewing frame 202.

In at least one example, the connectors 205a, 205b can be configured to be adjusted to increase the length of the arms 204a, 204b relative to the head 201. As shown in FIG. 2B, the arms 204a, 204b include a distal portion 208a, 208b, respectively, that can be adjusted to extend as shown. The first position 212a, 212b of the connectors 205a, 205b of the arms 204a, 204b, which results in the shorter securement arms 204a, 204b shown in FIG. 2A, is shown in solid lines. An adjusted second position 214a, 214b of the connectors 205a, 205b and thus arms 204a, 204b are shown extending further distal or back from the user's head 201. The distal portion 208a, 208b of each arm 204a, 204b can be adjusted by the user to accommodate the user's head 201 as shown to more securely hold the device 200 onto the user's head 201.

Any of the features, components, and/or parts, including the arrangements and configurations thereof shown in FIGS. 2A and 2B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 2A and 2B.

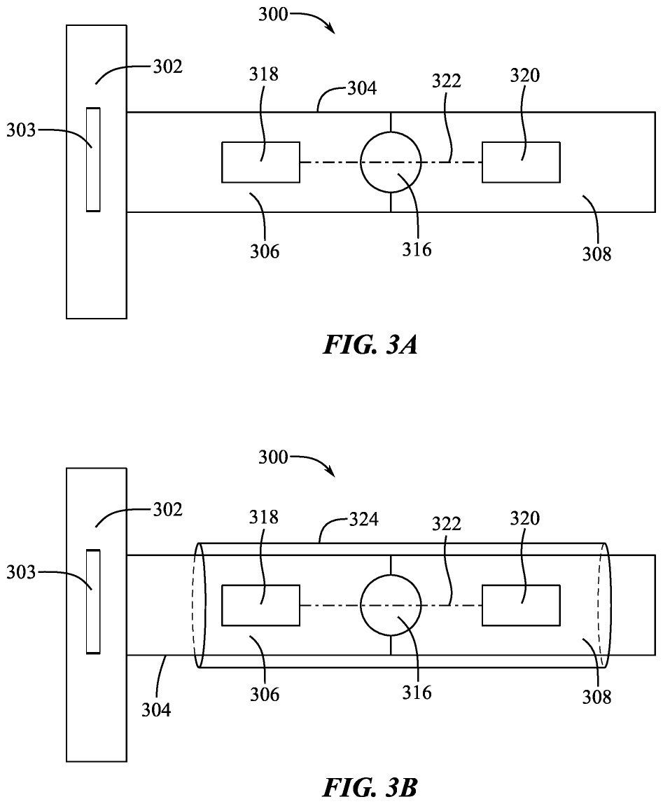

FIG. 3A shows a side view of an example of a head-mountable optical device 300, including a viewing frame 302, and a securement arm 304 extending from the viewing frame 302. As noted above, in some examples, the securement arm 304 can be hingedly or rotatably connected to the viewing frame 302. In some examples, the securement arm 304 can be fixedly or unmovably attached or secured to the viewing frame. In at least one example, the securement arm 304 can include a first portion 306 including a first electronic component 318 and a second portion 308 attached to the first portion 306 with a connector 316. The second portion 308 can include a second electronic component 320. Additionally, at least one example can include an electrical wire 322 extending through the connector 316 and electrically connecting the first electronic component 318 and the second electronic component 320.

As used herein, the term “connector” can refer to a structure or component enabling one portion of the arm 304 to laterally extend or move relative to another portion, for example the second portion 308 relative to the first portion 306. In some examples, the first and second portions 306, 308 can be separate pieces such that the connector 316 includes one or more structures connecting both separate pieces. In some examples, the arm 304 can include first and second portions 306, 308 that can contact at least a surface when in a first contracted arrangement and not directly contact when in a second extended or protracted arrangement. In other words, in an extended position, the connector 316 link and/or associate the first and second portions 306, 308 through the connector 316. In some examples the electrical wire 322 can extend through the connector 316. More details regarding various examples of connectors and connector structures are given below with reference to other figures.

In some examples, the arm 304 can include the distal portion 308 and the proximal portion 306 beginning proximally where the proximal portion 306 connects (cither rigidly or rotatably) to the viewing frame 302 and extending along a major length distally to a distal termination of the distal portion 308. In at least one example, a major length of the distal portion 308 is about 75% or less than a total major length of the arm 304. In at least one example, the distal portion is about 60% or less or about 50% or less of the total length of the arm 304. In some examples, the distal portion 308 of the arm 304 can be about 40% or less, about 30% or less, about 20% or less, about 10% or less, or about 5% or less than a total length of the arm 304. Correspondingly, the proximal portion can be at least about 25% of the total length of the arm 304 in one example, or at least about 40% of the total length of the arm 304 in another example. In one or more other examples, the proximal portion 306 can be at least about 50%, at least about 60%, at least about 70%, at least about 80%, at least about 90%, or at least about 95% of the total length of the arm 304.

The first and second electronic components 318, 320 can include any number of electronic components configured to operate and produce a virtual or augmented reality experience to the user through the device 300. For example, the first electronic component 318 can include a projector, waveguide, speaker, processor, or memory component and the second electronic component 320 can include a battery or any other component including those described with reference to the first electronic component 318. In examples where the electronic component 318 includes a projector and/or a waveguide, the projector and/or waveguide can be configured to project and light that is display on a window 303 secured to the viewing frame 302. The window 303 can include an optically transparent material. The window 303 can include an optical lens. The window 303 can include a transparent window through which light passes without redirecting light or vision correcting geometries. In examples where the second electronic component 320 includes a battery, the battery can be connected to the first electronic component 318 via the electronic circuitry component 322 to deliver power to the first electronic component 318.

In at least one example, the electronic circuitry component 322 can include one or more electrically conductive wires, flexes, resistors, circuit boards, or any other electronic circuitry components connecting the first electronic component 318 and the second electronic component 320. In at least one example, the electronic circuitry component 322 can include an electrical cable or wire. In some examples, the electrical cable or wire can include a planar flex.

Referring to FIG. 3B, in an example, the arm 304 can include a housing defining an external surface and an interior volume. The first electronic component 318, the second electronic component 320, and/or the electronic circuitry component can be disposed within the internal volume such that the components are hidden from view. Alternatively, one or more of the components shown 318, 320, and 322 can be disposed on the housing. The electronic circuitry component 322 can extend through the connector 316 such that the functionality of the connector 316 and the electronic circuitry component 322 is not hindered.

In some examples, the arm 304 can further include a sleeve 324. The connector 316 can be disposed within the sleeve 324. In some examples, at least a part or portion of the first and second portions 306, 308 of the securement arm 304 can be disposed within the sleeve 324. The sleeve 324 can function as a barrier between the connector 316 and the skin or hair of a user. In other words, in some examples, the sleeve 324 can keep any extendable portions or components that move relative to each other away from the hair or skin of the user to protect the user from pinching or scratching by the connector components and also interferes with the function of the connector 316. In some examples, the sleeve 324 can include at least one of elastane, a polyether-polyurea copolymer, a nylon, or a neoprene. In other examples, the sleeve 324 can include a hard or soft molded plastic such as polyethylene or a silicone material.

In at least one example, the device 300 can include an optical device and the first portion 306 of the arm 304 can be referred to as a proximal portion. In such an example, the second portion 308 of the arm 304 can be referred to as a distal portion. The terms “proximal” and “distal” can be used to reference the position of various components of devices described herein relative to the viewing frame 302 of the device 300. The orientation of the “proximal” and “distal” directions relative to devices described herein is shown in FIG. 1.

Referring to FIG. 3A, the electronic circuitry component 322 can extend from the proximal portion 306 to the distal portion 308 through the connector 316. In such an example, the electronic circuitry component 322 remains protected within an internal volume of the arm 304 within the proximal portion 306, distal portion 308, and the connector 316. In at least one example, the distal portion 308 extends relative to the proximal portion 306 at the connector 316 such that the length of the connector 316 and as such the length between the first electronic component 318 and the second electronic component 320 is variable. In this way, in at least one example, there is sufficient length of the electronic circuitry component 322 or electrical wire to retain an electrical connection between the first electronic component 318 and the second electronic component 320 when the connector 316 is extended. Thus, the electrical wire 322 can be coiled or compacted within the arm 304 or the connector 316 when the connector 316 is in a compact position.

Any of the features, components, and/or parts, including the arrangements and configurations thereof shown in FIGS. 3A-3B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 3A-3B.

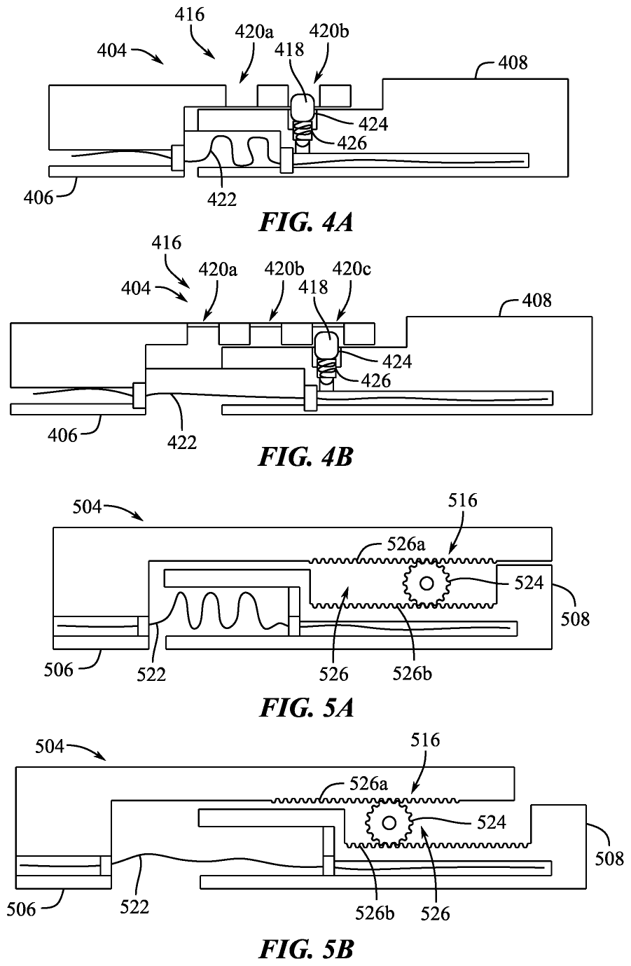

FIG. 4A shows a side view of an example of a securement arm 404, including a first proximal portion 406 and a second distal portion 408 and a connector 416. In the illustrated example, the connector 416 includes a ball detent mechanism 418. In some examples, the first proximal portion 406 can include a series of apertures 420a, 420b, 420c. For example, the first proximal portion 406 can include two, three, or up to several apertures. In some examples, the apertures 420a, 420b, 420c can be notches and/or depressions formed into a section of the first proximal portion 406 (e.g., as shown in FIG. 4B). In some examples, the ball detent mechanism 418 can include a ball 424 biased in an outward radial direction by a spring 426 toward one of the apertures (e.g., 420b). The ball 424 can be disposed in one of the apertures (e.g., 420b). As such, the ball 424 is configured to cooperate with the corresponding aperture to resist lateral movement of the first portion 406 and the second portion 408. In some examples, a user can manually depress the ball 424 to transpose the ball detent mechanism 418 to the desired aperture in the series of apertures 420a, 420b, and 420c. An electrical wire 422 is shown in FIG. 4A extending below the ball detent mechanism 418. As such, the electrical wire 422 extends through the connector 416. The electrical wire is coiled and/or clustered in a portion of the second distal portion 408 to provide enough slack or length to extend the connector 416 without disrupting the electrical connection between electronic components disposed in the first proximal portion 406 and a second distal portion 408 respectively.

FIG. 4B shows a side view of the arm 404 shown in FIG. 4A but with the distal portion 408 disposed in an extended arrangement. In other words, the ball detent mechanism 418 is configured with the ball 424 disposed in an extended aperture (e.g., 420c). As noted, the ball detent mechanism 418 can be compressed to compact the spring and then the distal portion 408 can be extended to move the ball 424 to a more distal aperture 420c. In other examples, to shorten and or compact the connector 416, the ball detent mechanism 418 can be compressed to compact the spring and then the distal portion 408 can be laterally translated toward the proximal portion 406 to shorten the connector 416. FIG. 4B shows the electrical wire 422 extended as the connector is extended.

Any of the features, components, and/or parts, including the arrangements and configurations thereof shown in FIGS. 4A and 4B can be included, cither alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 4A and 4B.

FIG. 5A illustrates a side view of another example of a securement arm 504, including a proximal portion 506 and a distal portion 508 attached to the proximal portion 506 at a connector 516. The connector 516 can include a rack-and-pinion linear gear arrangement 518. The connector 516 can include a circular gear 524 that engages a linear gear 526. In some examples, the linear gear 526 includes a first rack 426a coupled to or disposed on the proximal portion 506 and a second rack 426b coupled to or disposed on the distal portion 508. Generally, the rack-and-pinion linear gear arrangement 518 converts the rotational motion of the circular gear 524 to linear motion. Rotating the circular gear 524 causes the first rack 526a and the second rack 526b to move laterally in opposite directions, expanding the connector 516 and extending the securement arm 504. The circular gear 524 and the linear gear 526 contact at gear teeth. The size of the gear teeth determine the ratio of extension of the connector 516 to the rotation of the circular gear 524.

FIG. 5B illustrates a side view of the securement arm 504 with the connector 516 in an extended position. Similar to the embodiments shown in FIGS. 4A-4B, an electrical wire 522 is shown in FIG. 5A extending below the rack-and-pinion linear gear arrangement 518. As such, the electrical wire 522 extends through the connector 516. The electrical wire is coiled and/or clustered in a portion of the second distal portion 508 to provide enough slack or length to extend the connector 516 without disrupting the electrical connection between electronic components disposed in the first proximal portion 506 and a second distal portion 508 respectively. FIG. 5B shows the electrical wire 522 extended as the connector is extended.

Additionally, or alternatively, in at least one example, the arm 504, or the connector 516 of the arm 504, can include a knob or handle (not shown) that a user can manually operate disposed at or near the connector 516 or directly coupled to the circular gear 524. The knob can include a grip having an elastic material, including rubber, silicone, elastic polymers, or some combination of these or other elastic materials, disposed thereon.

In some examples, the connector 516 can include a motor (not shown) that actuates to adjust the length of the securement arm 504. For example, an electric motor that can be powered by battery and/or a rechargeable system can be coupled to the connector 516 and actuate to rotate the circular gear 524. The motor can be operated by a switch included on the securement arm 504, mounted anywhere on the optical or remotely.

Any of the features, components, and/or parts, including the arrangements and configurations thereof shown in FIGS. 5A and 5B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 5A and 5B.

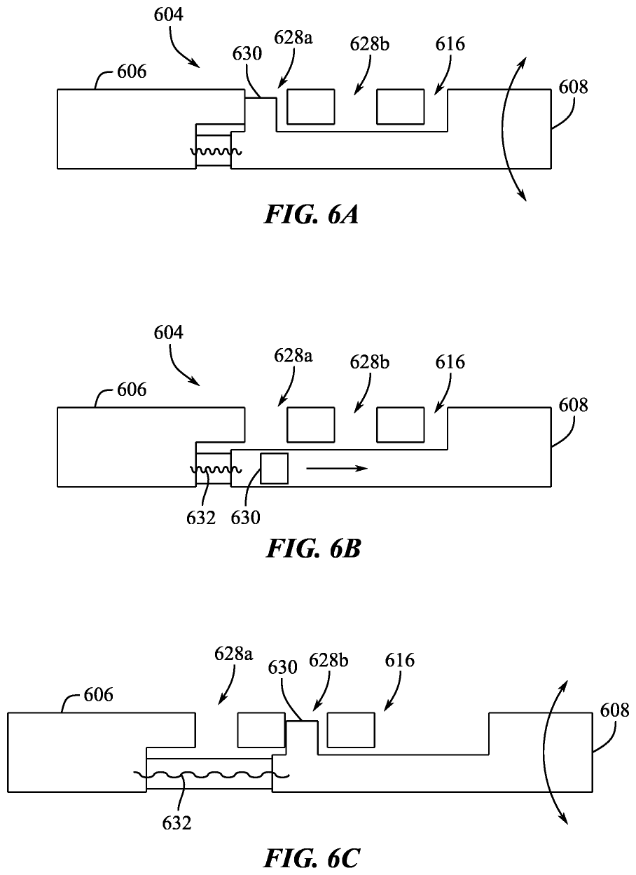

FIG. 6A illustrates a side view of another example of a securement arm 604, including a first proximal portion 606 and a second distal portion 608 secured to the proximal portion 606 at a connector 616. The connector 616 can include a cut away feature such as a notch 628 or series of notches 628a, 628b to engage a protrusion 630. The connector 616 can include a spring-biased twist gear. In some examples, the connector can include a compressed position and an extended position.

Referring to FIGS. 6B-6C, a rotation of the second distal portion 608 disengages the twist gear from the compressed position and a spring 632 extends the connector. A counter rotation of the second distal portion 608 engages the protrusion in the notch 628 and the connector 616 in the extended position. In other words, the second distal portion 608 can be rotated in a counterclockwise direction to release the protrusion 630 from the notch 628a. The spring 632 can either extend the connector 616 or a user can pull against the spring to extend the connector. The second distal portion 608 can be rotated in a clockwise direction to return the protrusion 630 to a second notch 628b, where the connector is in an extended state. The spring-biased twist gear provides an extendable securement arm 604 with a simple mechanism that is easy for a user to understand and operate.

Any of the features, components, and/or parts, including the arrangements and configurations thereof shown in FIGS. 6A-6C can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 6A-6C.

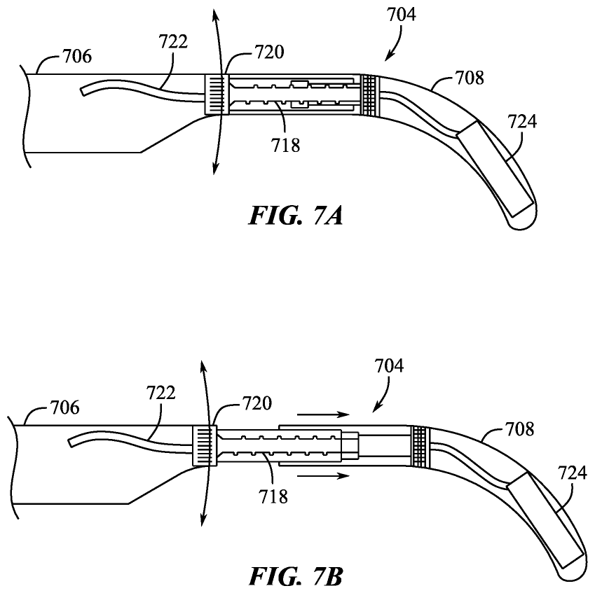

FIG. 7A illustrates a cross-section side view of another example of a securement arm 704, including a proximal portion 706 and a distal portion 708 attached to the proximal portion 706 at a connector 716. The connector 716 can include a screw extender 718. In some examples, the connector 716 can include a knob 720 that can be rotated by a user or a motor to turn the screw extender 718. In some examples, the connector 716 can include a worm gear arrangement. In other examples, as shown in FIG. 7A, the screw extender 718 can be in the same rotational plane as the knob such that when the knob 720 is rotated in a first direction (e.g., clockwise) the screw rotates in a threaded housing and the distal portion 708 extends in a lateral direction away from the proximal portion 706. Likewise, in some examples, when the knob 720 is rotated in a second direction (e.g., counter-clockwise) the screw rotates in a threaded housing and the distal portion 708 shortens or contracts in a lateral direction towards the proximal portion 706.

FIG. 7B illustrates a cross sectional side view of the securement arm 704 with the connector 716 in an extended position. An electrical wire 722 is shown in FIGS. 7A and 7B extending through a channel defined by the screw extender 718. In other words, the electrical wire 722 can pass through a hollow screw extender 718. The screw defines a channel and the electrical wire 722 is disposed within the channel. As such, the electrical wire 722 extends through the connector 716. In at least one example, the electronic circuitry component or wire 722 can include a flat, planar electrical flex, as shown in FIG. 7. The electrical wire can be coiled and/or clustered in a portion of the securement arm 704 to provide enough slack or length to extend the connector 716 without disrupting the electrical connection between electronic components disposed in the first proximal portion 706 and a second distal portion 708 respectively. For example, FIGS. 7A and 7B show a battery 724 connected to the electrical wire 722. The battery 724 can be disposed within the distal portion 708. In some examples, the battery 724 can provide a weight distribution of the securement arm 704 that is more comfortable for the user.

Any of the features, components, and/or parts, including the arrangements and configurations thereof shown in FIG. 7A and FIG. 7B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 7A and FIG. 7B.

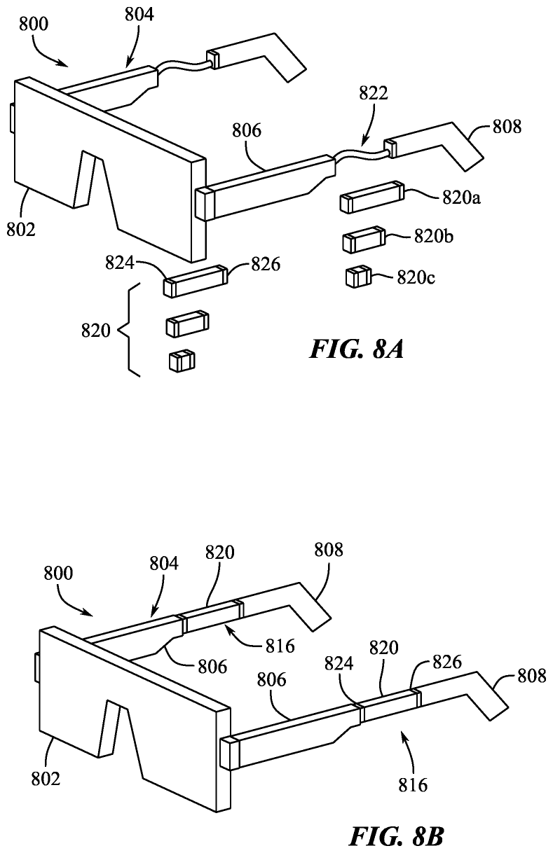

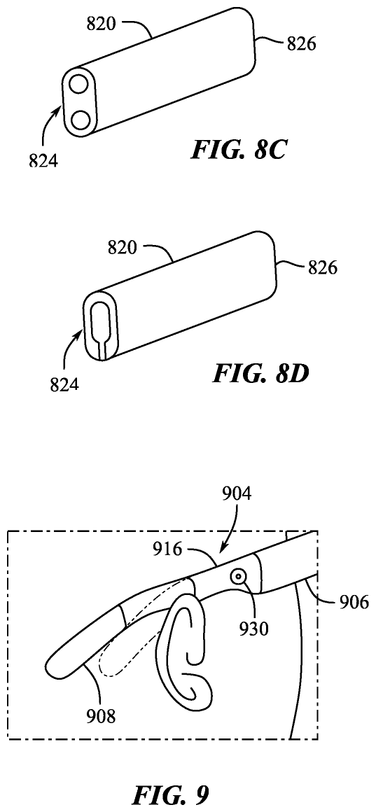

FIG. 8A shows a perspective view of an example head-mountable electronic device 800 having a viewing frame 802 and a securement arm 804, similar to that shown in FIGS. 1-3B. The securement arm 804 can include a first portion 806 and a second portion 808 attached to the first portion 806 via a connector 816 that includes an interchangeable extender 820. The interchangeable extender 820 can include a proximal end 824, a distal end 826, and defines a cavity. As shown in FIG. 8A, the interchangeable extender 820 includes a series of extenders 820a, 820b, 820c with variable lengths that can be exchanged by the user for proper fit, comfort, and/or features.

An electrical wire 822 is shown in FIG. 8A that extends through the cavity of the interchangeable extenders 820. In other words, the electrical wire 822 can pass through a hollow extender 820. In at least one example, the electronic circuitry component or wire 822 can include a flat, planar electrical flex, as shown in FIG. 8A.

Referring to FIG. 8B, the proximal end 824 of the extender 820 couples to the first portion 806 and the distal end 826 couples to the second portion 808. The electrical wire can be coiled and/or clustered in a portion of the securement arm 804 or in the extender 20 to provide enough slack or length to extend the connector 816 without disrupting the electrical connection between electronic components disposed in the first portion 806 and a second portion 808 respectively.

FIG. 8C and FIG. 8D show two example interchangeable extenders 820. In FIG. 8C, the proximal end 824 of the extender 820 couples to the first portion 806 and the distal end 826 of the extender 820 couples to the second portion 808 via a magnetic connection. The magnetic connection can include a first magnet disposed on the proximal end 824 of the extender 820 with a mating magnet disposed on the first portion 806. Further, a second magnet pair can be included at the distal end 826 of the extender 820 coupled to the second portion 808 of the securement arm 804. In FIG. 8D, the proximal end 824 of the extender 820 couples to the first portion 806 and the distal end 826 of the extender 820 couples to the second portion 808 in an interference fit. In other words, the extender 820 can be configured to couple to the first portion 806 and the second portion 806 with a clip, an adhesive, a snap feature, or other suitable fitting. Other fittings can be included, but in this configuration, the electrical cable or wire 822 can be configured to either extend through the extender 820 or the extender can include a conductor or wire therein that can couple to electrical connections at the proximal end 824 and distal end 826 of the extender. In other words, each of the extender lengths 820a, 820b, or 820c can include a conductive wire or circuit 822 disposed therein that can provide the electrical connection between electronic components disposed in the first portion 806 and a second portion 808 respectively. FIG. 8D, for example, shows a cavity where the electrical wire 822 can be disposed in the cavity and a housing of the extender 820 has a gap or channel where the electrical or conducting wire 822 can pass through when the extender 820 is installed or exchanged. FIG. 8C does not include a cavity but has a conducting wire 822 disposed within the extender 820 and is configured to operable and electrically couple with connectors disposed at or on the first portion 806 and the second portion 808 of the securement arm 804, respectively.

The interchangeable extender 820 can be formed of various materials, including composite materials, steels, and bulk metallic glass, which can be utilized based on material spring rates, strength, modulus, and other properties. In one example, the material of the extender 820 can be formed of one or more materials having spring rates high enough to provide stability on the user's head, but low enough not to feel too stiff and to be able to conform the arm 804 to the user's head. In addition, the material of the protective layer 832a can be high strength and low modulus materials. In one example, polymers can be used to form the extender 820 in order to withstand high amounts of strain.

Any of the features, components, and/or parts, including the arrangements and configurations thereof shown in FIGS. 8A through 8D can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 8A-8D.

FIG. 9 shows a perspective view of another example of a securement arm 904 of a head-mountable electronic device, for example a head-mountable optical device. The securement arm 904 can be coupled to a viewing frame (not shown) of the optical device. The securement arm 904 can include a proximal portion 906 connected to the viewing frame and a distal portion 908 attached to the proximal portion by an extendable coupling 916. The extendable coupling 916 can include a retainer 930 configured to secure and maintain the extendable coupling 916 at a predetermined length. In other words, the retainer 930 can be included on the securement arm 904 to lock the proximal portion 906 and the distal portion 908 in a predetermined arrangement. In at least one example, the retainer can include an adjustable set screw. The set screw can ensure the securement arm 904 retains a length. The retainer 930 can secure the extendable coupling 916 in a fixed arrangement regardless of the activity the user is engaged in. For example, the user can loosen the adjustable set screw to position the extendable coupling 916 to the desired length and/or arrangement and then tighten the adjustable set screw to lock the arrangement in a more permanent configuration.

In the illustrated example of FIG. 9, the retainer 930 is adjacent the extendable coupling 916. An extended arrangement is shown is solid lines and an optional shortened arrangement is shown in dashed. In at least one example, the retainer 930 can be disposed adjacent the proximal portion 906 or the distal portion 908 or even be disposed on the viewing frame or remotely.

Any of the features, components, and/or parts, including the arrangements and configurations thereof shown in FIG. 9 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 9.

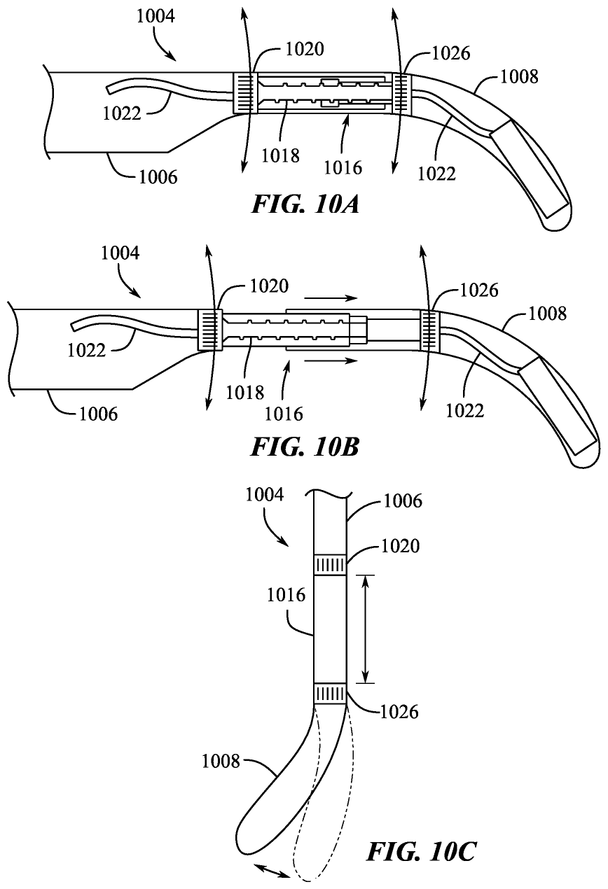

FIG. 10A illustrates a cross-section side view of another example of a securement arm 1004, including a proximal portion 1006 and a distal portion 1008 attached to the proximal portion 1006 at an extendable coupling 1016. The extendable coupling 1016 can include a screw extender 1018 similar to screw extender 1018 shown above in reference to FIGS. 7A-7B. In some examples, the extendable coupling 1016 can include a first set screw 1020 that can be rotated by a user or a motor to turn the screw extender 1018. In some examples, the extendable coupling 1016 can include a worm gear arrangement. In other examples, as shown in FIG. 10A, the screw extender 1018 can be in the same rotational plane as the first set screw 1020 such that when the first set screw 1020 is rotated in a first direction (e.g., clockwise) the screw rotates in a threaded housing and the distal portion 1008 extends in a lateral direction away from the proximal portion 1006. Likewise, in some examples, when the first set screw 1020 is rotated in a second direction (e.g., counterclockwise) the screw rotates in a threaded housing and the distal portion 1008 shortens or contracts in a lateral direction towards the proximal portion 1006. In some examples, the extendable coupling 1016 can include a second set screw 1026 that can be rotated by a user or a motor to adjust the arm tip angle. The second set screw 1026 can also have the same configurations as the first set screw.

In some examples, the second set screw 1026 can be rotated by a user or a motor to turn the screw extender 1018. In some examples, the extendable coupling 1016 can include a worm gear arrangement. In other examples, as shown in FIG. 10A, the screw extender 1018 can be in the same rotational plane as the second set screw 1026 such that when the second set screw 1026 is rotated in a first direction (e.g., clockwise) the distal portion 1008 adjusts an angle more acutely relative to the proximal portion 1006 to further secure the securement arm 1004 and, as such, the optical device to the head of the user. Likewise, in some examples, when the second set screw 1020 is rotated in a second direction (e.g., counterclockwise) the distal portion 1008 adjusts an angle relative to the proximal portion 1006 to return the angle more obtusely relative to the proximal portion 1006 of the securement arm 1004.

FIG. 10C illustrates a top view of the securement arm 1004 with the extendable coupling 1016. FIG. 10C shows the adjustments that can be made to the securement arm with the first set screw 1024 and the second set screw 1026. As described above by operating the first set screw 1024 the extendable coupling 1016 can be extended or contracted. By operating the second set screw 1026 the tip angle of the distal portion 1008 relative to the proximal portion 1006 can be adjusted. The tip angle can be more acute or obtuse relative to the proximal portion 1006. In other words, the distal portion 1006 can be adjusted to at least partially wrap around the head of the user to better secure the device. In examples of securement arms disclosed herein, the user can rotate the or adjust the distal portion of the securement arm to customize the angle or degree to which the securement arm extends around the user's head and over the user's ear to adapt to the user's head shape, size, and activity in which the user is participating. For example, adjusting the tip angle of the distal portion of a securement arm described herein can result in a great pinch force or pressure against opposing sides of the user's head between opposing securement arms as the distal portion rotates further around the rear portion of the head. This may be appropriate for active scenarios, including exercising, but the pressure from the securement arms may be uncomfortable for long periods of time during relaxed activities requiring less retention force from the securement arms.

Referring to FIGS. 10A and 10B, an electrical cable 1022 extends through a channel defined by the extendable coupling 1016. In other words, the electrical wire or cable 1022 can pass through a hollow screw extender 1018 or can pass around the screw extender 1018. In some examples, the screw defines a channel and the electrical cable 1022 is disposed within the channel.

Any of the features, components, and/or parts, including the arrangements and configurations thereof shown in FIGS. 10A-10C can be included, cither alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 10A-10C.

The present systems and methods can be used to interact with any number of environments. A physical environment or world, including physical features, object or surfaces, can be interacted with without using an electronic device. For instance, a physical environment may correspond to a physical city having physical buildings, roads, and vehicles. People may directly sense or interact with a physical environment through various senses, such as smell, sight, taste, hearing, and touch. This can be in contrast to an extended reality (XR) environment that may refer to a partially or wholly simulated environment that people may sense or interact with using an electronic device. The XR environment may include virtual reality (VR) content, mixed reality (MR) content, augmented reality (AR) content, or the like. Using an XR system, a portion of a person's physical motions, or representations thereof, may be tracked and, in response, properties of virtual objects in the XR environment may be changed in a way that complies with at least one law of nature. For example, the XR system may detect a user's head movement and adjust auditory and graphical content presented to the user in a way that simulates how sounds and views would change in a physical environment. In other examples, the XR system may detect movement of an electronic device (e.g., a laptop, tablet, mobile phone, or the like) presenting the XR environment. Accordingly, the XR system may adjust auditory and graphical content presented to the user in a way that simulates how sounds and views would change in a physical environment. In some instances, other inputs, such as a representation of physical motion (e.g., a voice command), may cause the XR system to adjust properties of graphical content.

Numerous types of electronic systems may allow a user to sense or interact with an XR environment. A non-exhaustive list of examples includes lenses having integrated display capability to be placed on a user's eyes (e.g., contact lenses), heads-up displays (HUDs), projection-based systems, head mountable systems, windows or windshields having integrated display technology, headphones/earphones, input systems with or without haptic feedback (e.g., handheld or wearable controllers), smartphones, tablets, desktop/laptop computers, and speaker arrays. Head mountable systems may include an opaque display and one or more speakers. Other head mountable systems may be configured to receive an opaque external display, such as that of a smartphone. Head mountable systems may capture images/video of the physical environment using one or more image sensors or capture audio of the physical environment using one or more microphones. Instead of an opaque display, some head mountable systems may include a transparent or translucent display. Transparent or translucent displays may direct light representative of images to a user's eyes through a medium, such as a hologram medium, optical waveguide, an optical combiner, optical reflector, other similar technologies, or combinations thereof. Various display technologies, such as liquid crystal on silicon, LEDs, uLEDs, OLEDs, laser scanning light source, digital light projection, or combinations thereof, may be used. In some examples, the transparent or translucent display may be selectively controlled to become opaque. Projection-based systems may utilize retinal projection technology that projects images onto a user's retina or may project virtual content into the physical environment, such as onto a physical surface or as a hologram.

The foregoing description, used specific nomenclature to provide a thorough understanding of the described embodiments. However, it will be apparent to one skilled in the art that the specific details are not required in order to practice the described embodiments. Thus, the foregoing descriptions of the specific embodiments described herein are only presented for purposes of illustration and description. They are not intended to be exhaustive or to limit the embodiments to the precise forms disclosed. It will be apparent to one of ordinary skill in the art that many modifications and variations are possible in view of the above teachings.

Various embodiments described herein can be improved on via the use of personal information data, gathered pursuant to authorized and well established secure privacy policies and practices that are appropriate for the type of data collected. However, the disclosed technology is not rendered inoperable in the absence of such personal information data.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

It will be understood that the details of the present systems and methods above can be combined in various combinations and with alternative components. The scope of the present systems and methods will be further understood by the following claims.

What is claimed is:

1. A securement arm for a wearable electronic device, comprising:
a first portion connected to a viewing frame of the optical device;
a second portion;
a connector attaching the second portion to the first portion, wherein the connector is configured to adjust a length of the securement arm; and
an electrical wire extending through the connector.

2. The securement arm of claim 1, wherein the connector comprises a ball detent mechanism, including:
a series of apertures defined by the first portion or the second portion;
a ball; and
a spring biasing the ball toward an aperture of the series of apertures;
wherein when the ball is disposed in the aperture, the ball resists a lateral movement of the first portion relative to the second portion.

3. The securement arm of claim 1, wherein:
the first portion and the second portion are operably connected via a rack-and-pinion linear gear mechanism; and
the second portion is configured to slide laterally with respect to the first portion between a retracted position and an extended position.

4. The securement arm of claim 1, wherein the connector includes a motor configured to adjust the length.

5. The securement arm of claim 1, further comprising a sleeve disposed over the connector.

6. The securement arm of claim 5, wherein the sleeve comprises at least one of elastane, nylon, or neoprene.

7. The securement arm of claim 1, wherein:
the connector comprises:
a twist gear configured to be engaged in a compressed position and an extended position; and
a spring biasing the twist gear and configured to extend the connector;
a first rotation of the second portion causes the twist gear to disengage from the compressed position; and
a second rotation of the second portion causes the twist gear to engage in the extended position.

8. The securement arm of claim 1, wherein:
the connector defines a cavity and comprises an interchangeable extender having a proximal end, and a distal end opposite the proximal end;
the proximal end connects to the first portion;
the distal end connects to the second portion; and
the electrical wire is disposed in the cavity.

9. The securement arm of claim 8, wherein the distal end couples to the second portion via an interference fit.

10. The securement arm of claim 8, wherein the distal end of the extender is coupled to the second portion via a magnet.

11. A head-mountable electronic device, comprising:
a viewing frame;
a securement arm extending from the viewing frame, the securement arm comprising:
a proximal portion connected to the viewing frame;
a first electronic component disposed in the proximal portion;
a distal portion;
an extendable connector securing the distal portion to the proximal portion; and
a second electronic component disposed in the distal portion; and
an electrical cable extending through the connector and electrically connecting the first electronic component and the second electronic component.

12. The head-mountable electronic device of claim 11, wherein the electrical cable comprises a planar flex.

13. The head-mountable electronic device of claim 11, wherein the second electronic component comprises a battery.

14. The head-mountable electronic device of claim 11, wherein the first electronic component comprises a speaker.

15. The head-mountable electronic device of claim 11, further comprising an elastic sleeve disposed over the connector.

16. The head-mountable electronic device of claim 11, wherein:
the connector comprises a screw extender including a screw;
a first rotation of the screw in a first direction extends the securement arm; and
a second rotation of the screw in a second direction shortens the securement arm.

17. The head-mountable electronic device of claim 16, wherein:
the screw defines a channel; and
the electrical cable is disposed in the channel.

18. A head mountable device, comprising:
a viewing frame;
a securement arm extending from the viewing frame, the securement arm including:
a proximal portion connected to the viewing frame;
a distal portion; and
an extendable coupling securing the distal portion to the proximal portion, the extendable coupling comprising a retainer configured to maintain the extendable coupling at a predetermined length.

19. The head mountable device of claim 18, wherein the retainer comprises an adjustable set screw.

20. The head mountable device of claim 19, wherein:
the adjustable set screw is a first set screw;
rotating the first set screw adjusts a length of the securement arm;
the retainer further comprises a second set screw; and
rotating the second set screw adjusts an angle of the distal portion relative to the proximal portion.
